(19) United States
(12) Patent Application Publication
(10) Pub. No.: US 2015/0009840 A1
(43) Pub. Date: Jan. 8, 2015

(54) PACKET TIME STAMP PROCESSING METHODS, SYSTEMS, AND APPARATUS

(71) Applicant: NIKSUN, INC., Princeton, NJ (US)

(72) Inventors: PARAG PRUTHI, Princeton, NJ (US); Viet Le, Marlton, NJ (US); Christopher Mac Stoker, Brooklyn, NY (US); Andrew Heybey, York, PA (US)

(21) Appl. No.: 14/323,603

(22) Filed: Jul. 3, 2014

Related U.S. Application Data
(60) Provisional application No. 61/842,716, filed on Jul. 3, 2013.

(51) Int. Cl. H04L 12/26

(52) U.S. Cl. CPC H04L 43/106; H04L 43/16; H04L 43/045
USPC 370/252

(57) ABSTRACT

Methods, systems, and apparatus for monitoring network devices and identifying packet anomalies are described herein. Anomalies may be identified by receiving packets from a network device at a network monitor, each packet having a first time stamp added by the network device, adding a second time stamp to the packets by the network monitor, comparing the first time stamp and the second time stamp of each packet, and identifying an anomaly associated with a packet in response to a difference metric generated based on the first and second time stamps exceeding a threshold.

### CROSS REFERENCE TO RELATED APPLICATIONS

This application claims priority to U.S. Provisional application Ser. No. 61/842,716 entitled PACKET TIME STAMP PROCESSING METHODS AND APPARATUS, filed on Jul. 3, 2013, the contents of which are incorporated fully herein by reference.

### FIELD OF THE INVENTION

The invention relates to monitoring packets and, more particularly, to generating and processing time stamp information associated with the monitored packets.

### BACKGROUND INFORMATION

It is routine for data and other information to be communicated via a communications or data network. A data network may include multiple end-user computers that communicate with each other through various paths that make up the network. The complexity of such computer networks can range from simple peer-to-peer connection among a relatively small number of machines, to local area networks (LANS), wide area networks (WANS) and, of course, the global computer network known as the Internet. The data and other information communicated via the networks is typically broken down into portions of information referred to as packets.

The volume of packets flowing through a network is immense. Problems related to processing of packets by devices that make up the network and to the flow of packets through the network can be very disruptive to the users of the network. Accordingly, there is an ever-present need for improved methods, system and apparatus to identify such problems.

### SUMMARY OF THE INVENTION

The invention is embodied in methods, systems and apparatus for monitoring network devices and identifying packet anomalies. Anomalies may be identified by receiving packets from a network device at a network monitor, each packet having a first time stamp added by the network device, adding a second time stamp to the packets by the network monitor, comparing the first time stamp and the second time stamp of each packet, and identifying an anomaly associated with a packet in response to a difference metric generated based on the first and second time stamps exceeding a threshold.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. Also, lines without arrows connecting components may represent a bi-directional exchange between these components. This emphasizes that according to common practice, the various features of the drawings are not drawn to scale. On the contrary, the dimensions of the various features are arbitrarily expanded or reduced for clarity. Included in the drawings are the following figures:

FIG. 1 depicts a network monitoring system in accordance with aspects of the invention;

FIG. 2 depicts a network monitoring system including a network monitor in accordance with aspects of the invention;

FIG. 3a depicts a packet with a preceding time stamp added by a network monitor in accordance with aspects of the invention;

FIG. 3b depicts a packet with an appended time stamp added by a network monitor in accordance with aspects of the invention;

FIG. 3c depicts a packet with a preceding time stamp added by a network device in accordance with aspects of the invention;

FIG. 3d depicts a packet with a preceding time stamp and an additional field added by a network device in accordance with aspects of the invention

FIG. 4a depicts a packet with a first time stamps added by a network device and a second time stamp added by a network monitor in accordance with aspects of the invention;

FIG. 4b depicts a packet with a first time stamps and an additional field added by a network device and a second time stamp added by a network monitor in accordance with aspects of the invention;

FIG. 5 depicts a flow chart of steps for processing timestamps associated with monitored packets in accordance with aspects of the invention;

FIG. 6 depicts of flow chart of steps for analyzing packet in accordance with aspects of the invention;

FIG. 6a and FIG. 6b are flow charts of steps of identifying anomalies for use in the packet analyzing process of FIG. 6;

FIGS. 6c, 6d, 6e, and 6f are flow charts of steps of determining the cause of the anomalies for use in the packet analyzing process of FIG. 6

FIG. 7 is a flow chart of steps for setting thresholds and monitoring characteristics in accordance with aspects of the invention; and

FIG. 8 is a flow chart of steps for modifying operation of active device in accordance with aspects of the invention.

### DETAILED DESCRIPTION OF THE INVENTION

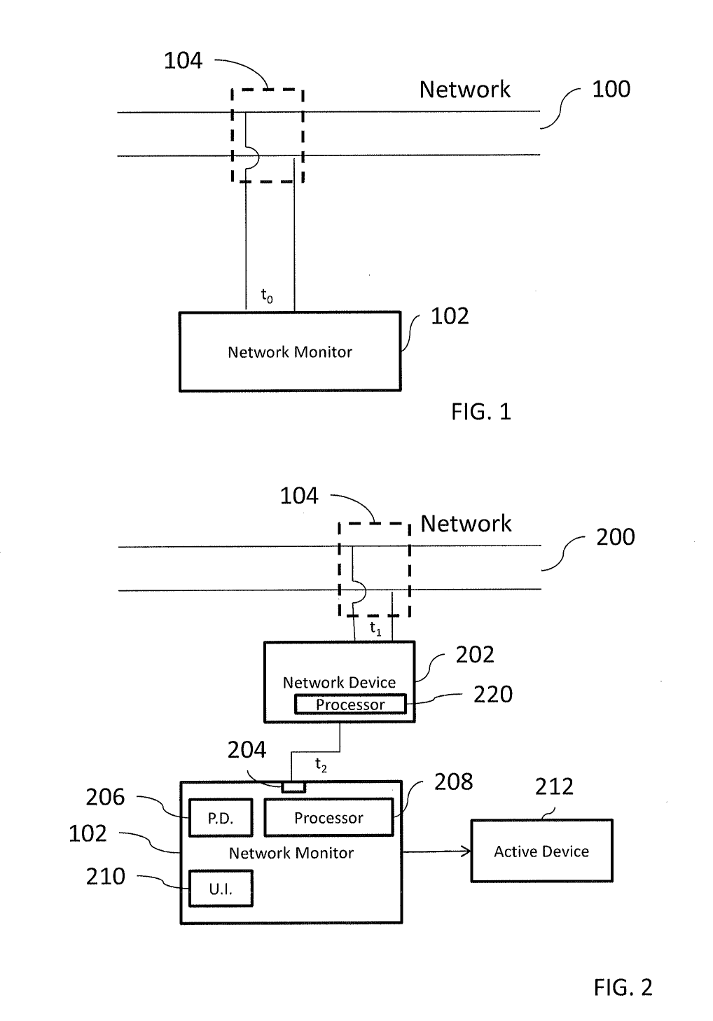

FIG. 1 depicts a network monitoring system 100 for monitoring packets passing through a location on a network. The network monitoring system 100 includes a network monitor 102 coupled to the network and may be a device such as a NetVCR or NetDetector available from Niksun, Inc. of Princeton, N.J.

The network monitor 102 is coupled to the network via a tap 104 and monitors packets passing through a location on the network. The tap 104 may be a conventional tap that will be understood by one of skill in the art from the description herein.

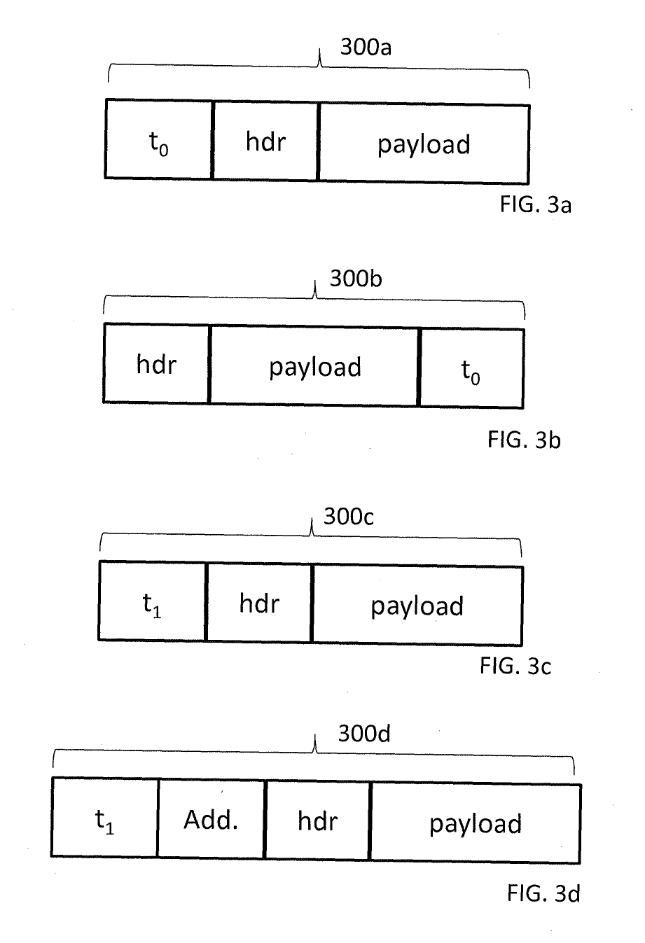

FIG. 2 depicts a network monitoring system 200 for capturing packets passing through a location on a network with a network device 202 and processing the packets with a network monitor 102. The network device 202 is configured to receive a packet from the network at a first time, t1, and to add a time stamp to the packet that corresponds to the time the packet was received by the network device. The network monitor 102 is coupled to the network device 202 (e.g., directly, via a network, etc.) and is configured to receive the packet from the network device 202 at a second time, t2, and to add a time stamp to the packet that corresponds to the time the packet was received by the network monitor 102. The network device 202 may be a network switch such as a Series 7150 network switch available from Arista Networks, Inc. of Santa Clara, Calif.

The illustrated network device 202 includes a processor 220. The processor 220 may be configured to provide the functionality of the network device. In addition to adding a time stamp when a packet is received, the processor 220 may be configured to add one or more additional fields to the packet. The additional field may be a field within the packet (e.g., packet type), a field derived from one or more fields within the packet, a field related to an operational parameter of the network device 202 (e.g., level of packet throughput), etc. The fields may be generated by an application running on the processor 220 of the network device 202. The processor 220 may be essentially any processing device including, by way of non-limiting example, a microprocessor, general purpose processor, specific purpose processor, field programmable gate array (FPGA), application specific integrated circuit (ASIC), etc.

The illustrated network monitor 102 includes a connection port 204 configured to receive packets from the network device 202 and a presentation device 206 (e.g., a display, speaker, external communication port, etc.). The network monitor 102 also includes a processor 208. The processor 208 may be essentially any processing device including, by way of non-limiting example, a microprocessor, general purpose processor, specific purpose processor, FPGA, ASIC, etc.

The processor 208 may be configured to add the second time stamp to the packet indicating when the packet was received by the network monitor, to compare the first time stamp and the second time stamp of each packet, and to identify an anomaly associated with the packet in response to a difference metric generated based on the first and second time stamps of one or more packets exceeding a threshold. In one example, the difference metric may be a difference between the first and second time stamps on a packet by packet basis. In another example, the difference metric may be an average difference between the first and second time stamps from multiple packets (e.g., in a series). The difference metric may be applied to all packets individually, to individual packets having a certain characteristics, to groups of packets having a certain characteristic, etc.

The processor 202 may alert a user of the network monitor 102 of an identified anomaly by setting an alert visible on a display or an audio alert that may be heard through the speakers. The illustrated network monitor 102 additionally includes a user interface 210 for setting the threshold(s) and/or identifying monitoring characteristics, for example, packet types associated with the threshold(s). The user interface may be, by way of non-limiting example, a local user interface (e.g., a mouse and/or keyboard) and/or a remote user interface (e.g., a web-based user interface that accesses the network monitor via a network connection).

The network monitor 102 may be coupled to an active device 212 (e.g., directly, via a network, etc.). The processor 208 of the network monitor 102 may alert the active device 212 of a packet anomaly and/or may provide instructions to the active device 212 based on the packet anomaly. For example, the processor 208 may instruct the active device 212 to cease certain processing in the event that an anomaly is identified. In an example, the active device 212 may be a high-frequency trading platform executing a trading algorithm based on packets flowing through the network. In the event that a packet anomaly is detected (indicating the data on which the trading platform is making trading decisions may be inaccurate), the processor 208 may shut down the trading algorithm in an attempt to mitigate loses that could arise from continuing to make trades based on inaccurate information.

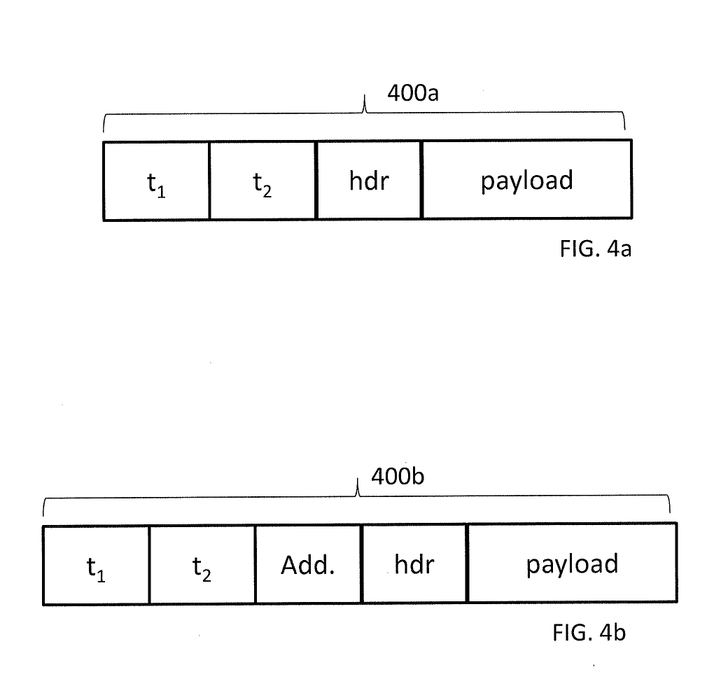

FIG. 3a depicts a data stream 300a that includes a captured packet (header (hdr) and payload information) along with a time stamp t0 added to the beginning of a captured packet by a network monitor 102 in accordance with aspects of the invention.

FIG. 3b depicts a data stream 300b that includes a captured packet (header (hdr) and payload information) along with a time stamp t0 added to the end of the captured packet by a network monitor 102 in accordance with aspects of the invention.

FIG. 3c depicts a data stream 300c that includes a captured packet (header (hdr) and payload information) along with a time stamp t1 added to the beginning of a captured packet by a network device 202 in accordance with aspects of the invention.

FIG. 3d depicts a data stream 300d that includes a captured packet (header (hdr) and payload information) along with a time stamp t1 and an additional field added to the beginning of a captured packet by a network device 202 in accordance with aspects of the invention.

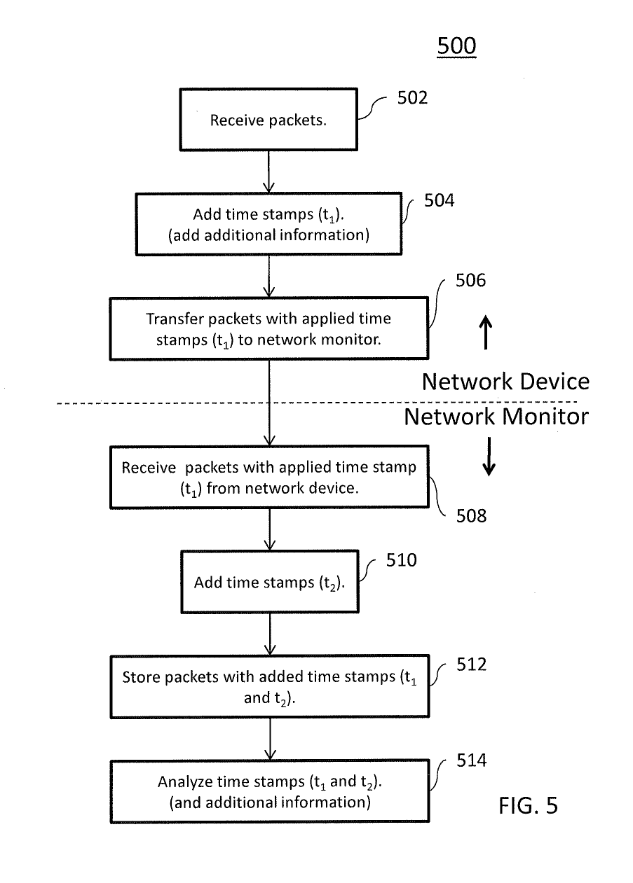

FIG. 4a depicts a data stream 400a that includes a captured packet (header (hdr) and payload information) along with a first time stamp added by a network device 202 and a second time stamp added by a network monitor 102 in accordance with aspects of the invention.

FIG. 4b depicts a data stream 400a that includes a captured packet (header (hdr) and payload information) along with a first time stamp and an additional filed added by a network device 202 and a second time stamp added by a network monitor 102 in accordance with aspects of the invention.

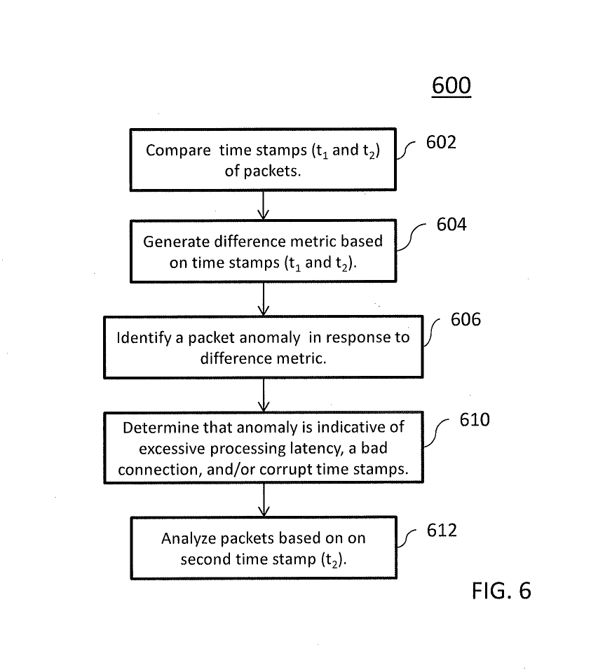

FIG. 5 depicts a method 500 of exemplary steps for generating and processing timestamps in accordance with aspects of the invention.

At block 502, packets are received. Packets may be received by a processor 220 of a network device 202 from a network.

At block 504, a time stamp (t1) is applied to the received packets. The time stamp (t1) represents the time at which the corresponding packet is received by the network device 202 from the network. The processor 220 may receive the packet and apply the time stamp (t1). Additionally, the processor 220 may generate one or more additional fields and apply the additional field(s) to the packet.

At block 506, the packets with the applied timestamps (t1) (and optional additional fields) are transferred to a network monitor. The processor 220 of the network device 202 may transfer the packets with the applied timestamps (t1) (and optional additional field(s) to the network monitor 102.

At block 508, the network monitor receives the packets with the applied timestamps from the network device. The processor 208 of network monitor 102 may receive the packets with the applied timestamps (t1) (and optional additional field) from the network device 202.

At block 510, a second time stamp (t2) is applied to the received packets. The second time stamp (t2) represents the time at which the packet is received by the network monitor. The processor 208 of the network monitor 102 may apply the second time stamp (t2) to the time stamp.

At block 512, the packets with the applied time stamps (t1 and t2) are stored. The network monitor 102 may store the packets with the applied time stamps (t1 and t2; and optional additional field) in an internal or an external memory.

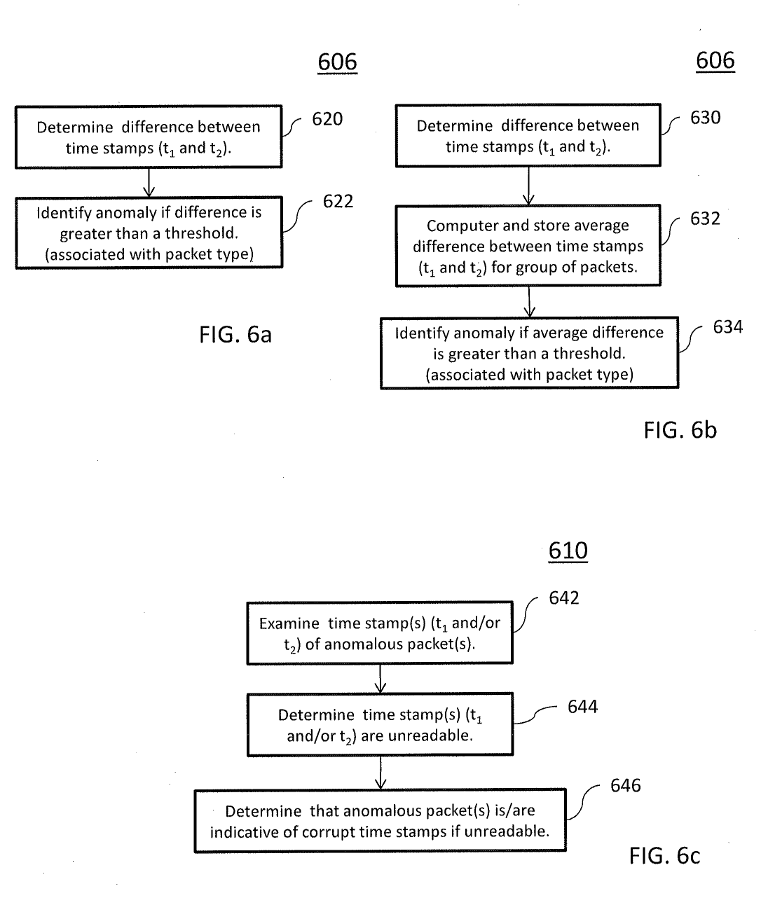

At block 514, the packets with the applied time stamps (t1 and t2) are analyzed. The packets may be analyzed with the network monitor 102. The time stamps may be compared to trouble shoot problems within the system, e.g., as described below with reference some specific embodiment, FIG. 6, and FIGS. 6a-6f.

In an embodiment, the difference in time between the first time stamp (t1) and the second time stamp (t2) is determined. If there is a relatively large difference (e.g., 10s of milliseconds) between the first time stamp (t1) and the second time stamp (t2) for a given packet, this may indicate a problem with a connection between the network device 202 and the network monitor 102. The relatively large difference may indicate an unacceptable latency of the network device 202 in processing and transferring received packets to the network monitor 102. In an exemplary embodiment, the difference is compared to a specified latency of the network device 202 to determine whether (or when or how frequently) the actual latency exceeds the specified latency. The time stamps may also be used to provide system redundancy in the event one of the time stamps (t1 or t2) becomes corrupted. Other advantages will be apparent to one of skill in the art from the description herein and are considered within the scope of the invention.

In another embodiment, the difference in time between the first time stamp (t1) and the second time stamp (t2) is determined for each of a plurality of packets and the variation of the difference among the plurality of packets is determined. A threshold may be determined or provided and if the variation exceeds the threshold, an alert may be generated. The alert may indicate an unacceptable variation of the latency in the processing and transferring of received packets by the network device 202 to the network monitor 102.

In an embodiment, the duration of time for the network device 202 to receive, process, and transfer packets to the network monitor 102 varies by type of packet where the “type” may be one or more of the size/length of the packet, the type of payload (e.g., application, protocol), etc. In this embodiment, the difference in time between the first time stamp (t1) and the second time stamp (t2) is determined for each of a plurality of packets. The differences are each compared to one of a plurality of thresholds where each of the plurality of thresholds corresponds to the particular type of the corresponding packet. An alert may be generated if the variation exceeds the corresponding threshold.

FIG. 6 depicts a flow chart 600 illustrating a technique for processing packet time stamps to identify anomalies. The steps of flow chart 600 are described with reference to FIG. 2 to facilitate description. Other suitable systems for implementing this and other techniques/method/processes described herein will be understood by one of skill in the art from the description herein. Additionally, it will be recognized that one or more of the steps of the techniques/method/processes described herein may be performed out of order and/or omitted without departing from the spirit and scope of the invention.

At step 602, the time stamps (t1 and t2) of the packets are compared and, at step 604, a difference metric is generated. The processor 208 of network monitor 102 may compare the time stamps and generate the difference metric. In one embodiment, the difference metric may be a difference between the time stamps (t1 and t2) for individual packets compared to a threshold (e.g., a value between 10 milliseconds and 90 milliseconds, a value of a microsecond, a value lower than a microsecond). In another embodiment, the difference metric may be an average difference between the time stamps (t1 and t2) for multiple packets, e.g., in a series, compared to a threshold. The processor 208 may keep track of additional information such as packet type and determine the difference metric based in part of the additional information, e.g., an average difference between the time stamps (t1 and t2) for multiple packets having the same packet type in a series compared to a threshold. Different thresholds may be established for different packets, e.g., based on a packet type or group of packet types.

At step 606, packet anomalies are identified in response to the difference metric. The packet anomalies may be identified by the processor 208 of the network monitor 102. Additional details regarding the detection of packet anomalies are described below with reference to FIGS. 6a and 6b.

At step 610, a determination is made regarding the reason for the occurrence of the anomaly. The determination may be made automatically by the processor 208 of the network monitor 102 and/or manually using the user interface 210 of the network monitor 102 to examine the packets received from the nework device 202. Additional details regarding the automatic determination of the anomalies are described below with reference to FIGS. 6c-6f.

At step 612, packets are analyzed based on the second time stamp added by the network monitor. The packets may be analyzed automatically and/or manually via the processor 208 of the network monitor 102. For example, if it determined that the first time stamps are corrupt, the second time stamps (which will typically have a difference from the first time stamps of a few tens of miliseconds or less) may be used to analyze the packets instead.

FIG. 6a depicts a method for identifying an anomaly. At step 620, a difference between a first time stamp and a second time stamp of each packet is determined, e.g., by processor 208. At step 622, an anomaly is identified, e.g., by processor 208, if the difference in the packet's time stamps is greater than a threshold value. Thus, an anomaly may be identified based on a single packet regardless of the difference in time stamps for other packets. Thresholds may be assigned based on packet characteristics (e.g., packet type, packet size, etc.) with different packets compared to different thresholds to identify anomalies. For example, larger packets may be associated with higher thresholds.

FIG. 6b depicts another method for identifying an anomaly. At step 630, a difference between a first time stamp and a second time stamp of each packet is determined, e.g., by processor 208. At step 632, an average difference in timestamps may be computed and stored for a series of packets, e.g., by processor 208. At step 634 an anomaly is identified is the average difference is greater than a threshold value, e.g., by processor 208. Thresholds may be assigned based on packet characteristics (e.g., packet type, packet size, etc.) with different groups of packets compared to different thresholds to identify anomalies. For example, a group of video packets may be associated with higher thresholds than a group of audio packets.

FIG. 6c depicts a method for determining the cause of the anomaly. At step 642, the time stamps (t1 and/or t2) are examined, e.g., by processor 208. The processor 208 determines whether the time stamps are readable at step 644. If a time stamps cannot be read, the processor 208 determines at step 646 that the anomalous packet determination is indicative of a corrupt time stamp, which may be communicated to a user, e.g., via presentation device 206 of network monitor 102.

FIG. 6d depicts another method for determining the cause of the anomaly. At step 652, the time stamps (t1 and/or t2) are examined, e.g., by processor 208. The processor 208 determines whether the difference in the time stamps of the anomalous packets are an order of magnitude greater than the difference in time stamps of other packets at step 654. The other packets may be related to the anomalous packet, e.g., having similar/identical characteristics and received at substantially the same time. If an anomalous packet having a time stamp difference that is an order of magnitude greater than for other packets, the processor 208 determines at step 656 that the anomalous packet determination is indicative of excessive processing latency by the network device 202, which may be communicated to a user, e.g., via presentation device 206 of network monitor 102.

FIG. 6e depicts another method for determining the cause of the anomaly. At step 662, the time stamps (t1 and/or t2) of anomalous packets of one type are compared to non-anomalous packets of another type, e.g., by processor 208. The processor 208 determines whether the difference in the time stamps of the packets for one type of packet are experiencing unexpected delays with respect to another type (e.g., audio versus video) at step 664. If anomalous packets of one type (e.g., audio) are experience an unexpected delay (e.g., greater than 25 milliseconds) with respect to non-anomalous packets of another type, the processor 208 determines at step 666 that the anomalous packet determination is indicative of excessive processing latency by the network device 202, which may be communicated to a user, e.g., via presentation device 206 of network monitor 102.

FIG. 6f depicts a method for determining the cause of the anomaly. At step 672, the time stamps (t1 and/or t2) of packets in a data stream are examined, e.g., by processor 208. The processor 208 determines whether the time stamps are in their expected positions within the data stream at step 674. If the time stamps (t1 and/or t2) are not in their expected positions, the processor 208 determines at step 676 that the anomalous packet determination is indicative of a connection problem between the network device 202 and the network monitor 102, which may be communicated to a user, e.g., via presentation device 206 of network monitor 102.

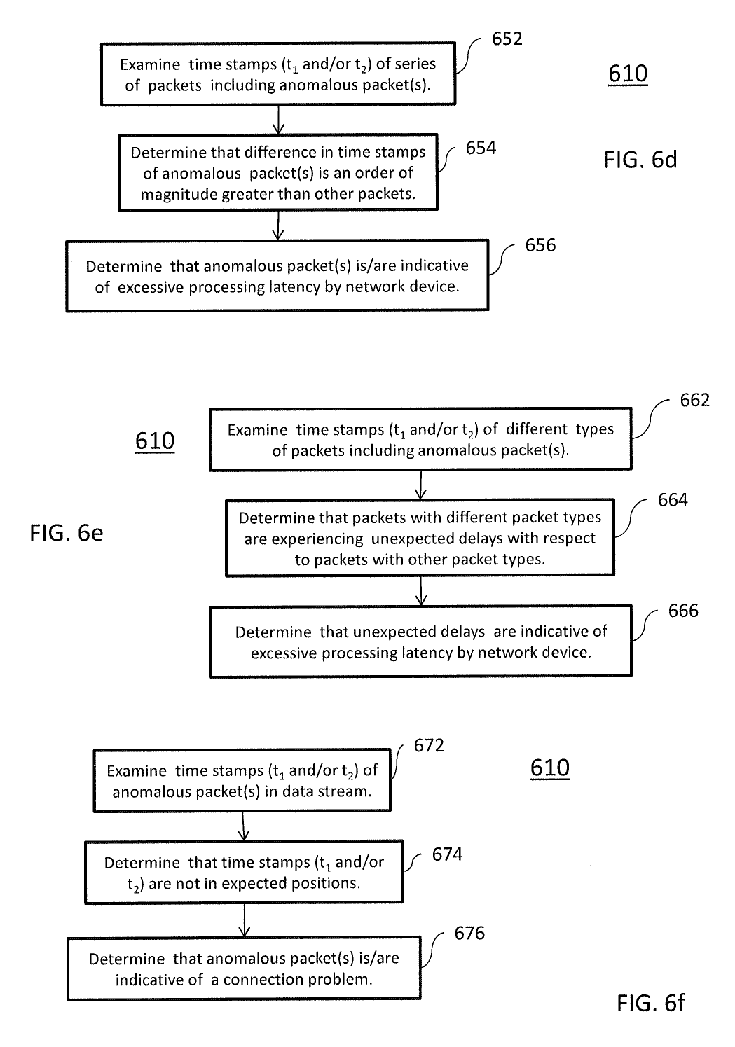

FIG. 7 depicts a flow chart 700 of steps for setting thresholds and monitoring characteristics. At step 702, threshold and/or monitoring instructions are received. The threshold and/or monitoring instructions may be received by the processor 208 from a user of the network monitor 102 via the user interface 210. At step 704, the threshold and/or monitoring characteristics are set, e.g., by the processor 208, based on the received instructions. A threshold may be independent of a packet characteristic with the same threshold applied to all packets or may be dependent on a characteristic of the packet (e.g., packet types, service levels) with different thresholds set based on different characteristics.

The threshold(s) can be defined and implemented in other ways. In one example, the threshold can be defined programmatically, e.g., by an algorithm running on another device coupled to the network monitor or running on the network monitor itself. This enables the threshold to be flexibly defined, e.g., it can change over time even as packets are being received. For example, if the number of anomalous packets detected exceeds a predefined rate, e.g., 1,000 per hour, the threshold may be raised so that the number of anomalous packets identified in a particular time period for review is lowered to a reasonable level. Alternatively, if the number of anomalous packets detected is below a predefined rate, e.g., 1 per hour, the threshold may be lowered so that the number of anomalous packets identified in a particular time period for review is raised to a reasonable level.

In another example, the threshold can be defined based on historical difference values. For example, the threshold may be set at 10% above the average difference values for packets received in the last 10 minutes.

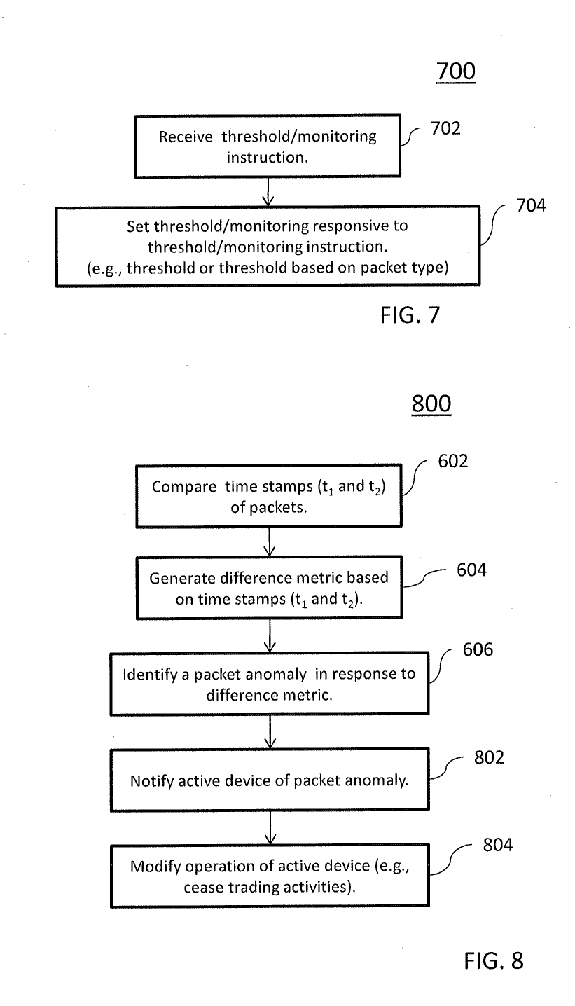

FIG. 8 depicts a flow chart 800 of steps for modifying operation of an active device. Steps 602, 604, and 606 may be the same as described above with reference to FIG. 6 and are not elaborated on further.

At step 802, an active device is notified of a packet anomaly. The processor 208 of network monitor 102 may notify the active device 212 (e.g., a high frequency trading platform of the anomaly.

At step 804, operation of the active device is modified. In one example, the active device 212 may be configured to modify its operation based on the notification from the network monitor 102 in step 802. In another example, the processor 208 of network monitor 102 may instruct the active device 212 to modify its operation. The modification may be, for example, ceasing to perform trading activities until the cause of the anomaly can be assessed.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A network monitor for monitoring a network device coupled to a network, the network device receiving packets and adding a first time stamp to the packets, the network monitor comprising:
a connection port configured to receive at least one packet from the network device;
a presentation device; and
a processor coupled to the connection port and the presentation device, the processor configured to add a second time stamp to the at least one packet, compare the first time stamp and the second time stamp of each of the at least one packet, and identify an anomaly associated with the at least one packet in response to a difference metric generated based on the first and second time stamps of a set of one or more packets exceeding a threshold.

2. The network monitor of claim 1, further comprising:
a user interface coupled to the processor;
the user interface configured to receive a threshold instruction from a user for setting the threshold; and
the processor further configured to set the threshold responsive to the threshold instruction.

3. The network monitor of claim 1, wherein the set includes two or more packets and wherein the processor is configured to identify the anomaly when the average difference between the first and second time stamps of the two or more packets exceeds the threshold.

4. The network monitor of claim 1, wherein the threshold is between 10 milliseconds and 90 milliseconds.

5. The network monitor of claim 1, wherein the anomaly is indicative of at least one of excessive processing latency by the network device, a bad connection between the network device and the network monitor, or a corruption of the first time stamp.

6. The network monitor of claim 1, wherein the processor of the network monitor is further configured to analyze the received at least one packets based on the second time stamp added by the network monitor.

7. The network monitor of claim 1, wherein the processor of the network monitor is further configured to compare a type of each of the at least one packet to a set of one or more predefined packet types associated with the threshold and wherein the processor of the network monitor is configured to identify the anomaly further based on a match between the type of the at least one packet and the one or more predefined packet types in the set.

8. The network monitor of claim 7, wherein the processor of the network monitor is further configured to compare the type of each of the at least one packet to another set of one or more predefined packet types associated with another threshold and wherein the processor of the network monitor is configured to identify the anomaly further based on a match between the type of the at least one packet and the one or more predefined packet types in the other set and the difference metric generated based on the first and second time stamps of the set of one or more packets exceeding the other threshold.

9. The network monitor of claim 7, further comprising:
a user interface coupled to the processor;
the user interface configured to receive a monitoring instruction from a user for identifying packet types associated with the set of one or more packets; and
the processor further configured to define the set of one or more packets responsive to the monitoring instruction.

10. A network monitoring method comprising:
receiving at least one packet from a network device at a network monitor, each packet having a first time stamp added by the network device;
adding a second time stamp to the at least one packet by the network monitor;
comparing the first time stamp and the second time stamp of each of the at least one packet; and identifying an anomaly associated with the at least one packet in response to a difference metric generated based on the first and second time stamps of a set of one or more packets exceeding a threshold.

11. The method of claim 10, further comprising:
receiving a threshold instruction from a user for setting the threshold; and
setting the threshold responsive to the threshold instruction.

12. The method of claim 10, wherein the set includes two or more packets and wherein the anomaly is identified when the average difference between the first and second time stamps of the two or more packets exceeds the threshold.

13. The method of claim 10, further comprising:
determining that the anomaly is indicative of at least one of excessive processing latency by the network device, a bad connection between the network device and the network monitor, or a corruption of the first time stamp.

14. The method of claim 10, further comprising:
analyzing the received at least one packet based on the second time stamp added by the network monitor.

15. The method of claim 10, further comprising:
comparing a type of each of the at least one packet to a set of one or more predefined packet types associated with the threshold;
wherein the anomaly is identified further based on a match between the type of the at least one packet and the one or more predefined packet types in the set.

16. The method of claim 15, further comprising:
comparing the type of each of the at least one packet to another set of one or more predefined packet types associated with another threshold;
wherein the anomaly is identified further based on a match between the type of the at least one packet and the one or more predefined packet types in the other set and the difference metric between the compared first and second time stamps of the set of one or more packets exceeding the other threshold.

17. The method of claim 15, further comprising:
receiving a monitoring instruction from a user for identifying packet types associated with the set of one or more packets; and
defining the set of one or more packets responsive to the monitoring instruction.

18. A network monitoring system comprising:
a network device coupled to a network, the network device configured to receive packets and to add a first time stamp to the packets; and
a network monitor coupled to the network device, the network monitor configured to receive at least one packet with the added first time stamp from the network device, add a second time stamp to the at least one packet, compare the first time stamp and the second time stamp of each of the at least one packet, and identify an anomaly associated with the at least one packet in response to a difference metric generated based on the first and second time stamps of a set of one or more packets exceeding a threshold.

19. The network monitoring system of claim 18 wherein the network monitor is further configured to compare a type of each of the at least one packet to a set of one or more predefined packet types associated with the threshold and to identify the anomaly further based on a match between the type of the at least one packet and the one or more predefined packet types in the set.

20. The network monitoring system of claim 18, wherein the set includes two or more packets and wherein the anomaly is identified when the average difference between the first and second time stamps of the two or more packets exceeds the threshold.
